(19) United States
(12) Patent Application Publication
(10) Pub. No.: US 2011/0026692 A1
(43) Pub. Date: Feb. 3, 2011

(54) MESSAGING FEATURES FOR PHONECASTING SYSTEMS

(75) Inventor: Michael A. Sharp, Porter, TX (US)

Correspondence Address: James G. Stewart PC, 335 NE 128th Avenue, Portland, OR, 97230, US

(73) Assignee: PATENT HOLDINGS, LLC, PORTER, TX (US)

(21) Appl. No.: 12/736,523

(22) PCT Filed: Apr. 17, 2009
(86) PCT No.: PCT/US09/40985

§ 371 Date: Oct. 14, 2010

Related U.S. Application Data
(60) Provisional application No. 61/045,814, filed on Apr. 17, 2008.

(51) Int. Cl. H04M 1/64

(52) U.S. Cl. 379/88.23

(57) ABSTRACT

A disclosed phonecasting system and method involves receiving a telephone call from a caller via a telephone number, and providing an audio signal in response. An audio file including audio content corresponding to the telephone number is played, thereby producing the audio signal. A message is selectively sent to the caller while the audio signal is being provided to the caller. The audio file may include, for example, a podcast publicly available via the Internet. The audio file may also include an audio advertisement or public service message. The message may be, for example, a text message or an electronic mail (email) message. Alternatively, or in addition, the message may be or include one or more images (e.g., pictures, drawings, diagrams, and the like).

### CROSS-REFERENCE TO RELATED APPLICATIONS

This Application claims priority to U.S. Provisional Application Ser. No. 61/045,814, filed Apr. 17, 2008, and entitled MESSAGING FEATURES FOR PHONECASTING SYSTEMS, by inventor M. Sharp, hereby incorporated herein by reference in its entirety. This Application also relates to commonly owned U.S. patent application Ser. No. 11/877,612, filed Oct. 23, 2007 and entitled “PHONECASTING SYSTEMS AND METHODS” by inventors M. Kaufman, M. Sharp, and C. Coleman.

### BACKGROUND

With the development of Apple Inc.'s iPod®, portable players for digital media entered the mainstream. Such portable media players routinely provide compact storage and playback of thousands of songs, and recent models include capabilities for storing and playing videos as well. The widespread availability of such devices created a platform for a new method of communication: podcasting. The term “podcast” is a combination of the words “iPod” and “broadcast”, and it in essence refers to the ability to syndicate an audible program to subscribers' portable media players.

The podcasting process begins with a content provider publishing an audio file on the Internet. The content provider then references that audio file in a syndication file, which in addition to the uniform resource locator (URL) of the audio file, typically includes additional information such as title, description, publication date, etc., of the audio program along with similar information for previous episodes of the program. The syndication file is commonly in a Really Simple Syndication (RSS) format, though other standard formats are also suitable. The syndication file has a fixed URL so that software on subscribers' computers can periodically check for new material. When new material is detected, the software typically downloads the newest audio file automatically so that it can be easily transferred to the portable media players the next time a synchronization is performed. In this manner, owners of media players are theoretically able to maintain dynamic and current content on their media players for “on the go” listening.

Podcasting has achieved widespread success. However, the podcasting process may have a number of shortcomings that have not been adequately identified and addressed heretofore. For example, podcast subscribers are required to have some amount of foresight regarding their listening preferences when subscribing and, moreover, must remember to charge, synchronize, and bring their portable media players (and headphones) with them for every circumstance in which they might wish to listen to their preferred podcast content. Often, some oversight in the subscribing, downloading, charging, synchronization, and custody process will leave a user without any ability to listen to the latest podcast material.

As another example, the podcast process typically imposes a significant degree of latency between the publication of the material and the subscriber's listening experience. For some subscribers, this latency is undesirable. It is perhaps unsurprising that, according to a consumer survey reported by TDG (The Diffusion Group) Research, the vast majority of downloaded podcasts are never transferred to a portable media player, but rather are played directly on networked computers.

### BRIEF DESCRIPTION OF THE DRAWINGS

A better understanding of the various disclosed embodiments can be obtained when the detailed description is considered in conjunction with the following drawings, in which:

FIG. 1 is a diagram of a system including an illustrative phonecasting system;

FIG. 2 is a diagram of one embodiment of a network server;

FIG. 3 is a function diagram of illustrative phonecasting system software;

FIG. 4 shows a mobile phone displaying a portion of a received text message on a display screen;

FIG. 5 is a flowchart of an illustrative phonecast listening method;

FIG. 6 is a flowchart of an illustrative phonecast playback method;

FIG. 7 is a flowchart of an illustrative phonecast setup method;

FIG. 8 is a flowchart of an illustrative automated download method;

FIG. 9 is a flowchart of an illustrative phonecast parameter configuration method;

FIG. 10 is a flowchart of an illustrative phonecast setup method for publishers;

FIG. 11 is a flowchart of an illustrative ad setup method for advertisers; and

FIG. 12 is a flowchart of an illustrative phonecast system setup method for administrators.

While the disclosed inventions are susceptible to various modifications and alternative forms, specific embodiments thereof are shown by way of example in the drawings and will herein be described in detail. It should be understood, however, that the drawings and detailed description thereto are not intended to limit the inventions to the particular form disclosed, but on the contrary, the intention is to cover all modifications, equivalents and alternatives falling within the spirit and scope of the inventions as defined by the appended claims.

### TERMINOLOGY

The term “feed” as used herein refers to a program, presentation, or other content made available for transmission or conveyance via the Internet. A feed can exist in various forms, including a podcast, a song or other fixed sound file, a periodically updated sound file, and a live media stream.

The term “phonecast,” when used herein as a noun, refers to a feed that can be accessed with a phone over the public switched telephone network (PSTN) and/or over a voice over internet protocol (VoIP) channel. When used herein as a verb, the term “phonecast” refers to the transmission or conveyance of a feed over a VoIP or PSTN channel to a phone.

The term “includes” as used herein is an open-ended term, as in “including, but not limited to”.

### DETAILED DESCRIPTION

To at least partly address some of the above-identified shortcomings of the podcasting process, the present application discloses a number of inventive phonecasting system and method embodiments having text messaging features. In some phonecasting method and system embodiments, a call to a number associated with a publicly-accessible Internet feed is answered by a playback of a publicly-accessible Internet feed. During, or shortly after, the playback, the phonecasting system sends a text message or email to the caller to provide additional information. The text message or email may be sent automatically or in response to the caller's request. It may include supplementary information such as recipes, coupons, specifications, retail locations, or other details deemed beneficial to the caller.

At least some of the foregoing phonecasting methods and systems enable free public access to Internet content via any phone, thereby eliminating or mitigating many of the shortcomings of the podcasting process. Users need only obtain the phone numbers for their preferred podcasts (or other Internet content) to be able to access the latest content from any phone. Phone number sharing and publication will also make such content instantly available to new users as well.

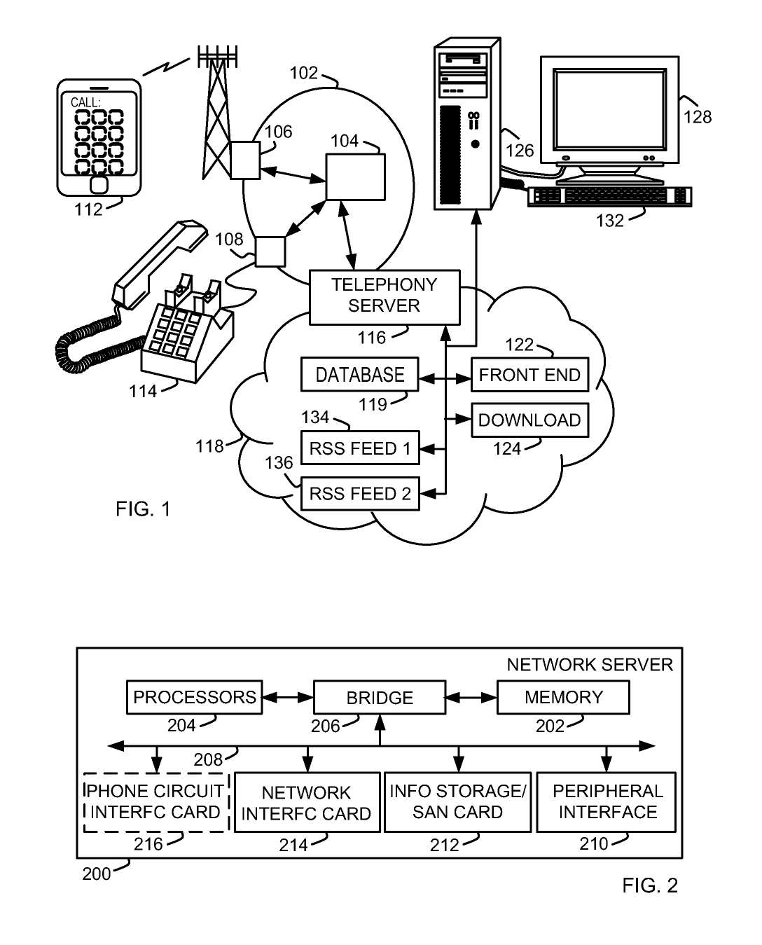

FIG. 1 is a diagram of a system including an illustrative phonecasting system. The public switched telephone network (PSTN) 102 includes a hierarchy of switches 104, 106, 108, and communication links that interconnect customer provided equipment (CPE) such as cell phones 112, “land-line” phones 114, and modems. A telephony server 116 couples to the PSTN 102 to initiate and receive phone calls. Often (though not necessarily) the telephony server 116 connects to the PSTN 102 via a trunk line that supports multiple simultaneous calls.

The telephony server 116 also couples to the Internet 118 to optionally send and receive streams of audio data. Alternatively, sound files can be played and recorded internally by telephony server 116. Telephony server 116 may be an Asterisk™ server (or a farm of such servers), the setup and operation of which is described in detail in J. Van Meggelen, J. Smith, and L. Madsen, Asterisk: The Future of Telephony, © 2005 O′Reilly Media, Inc., Farnham.

Together with the telephony server 116, the illustrative phonecasting system includes a database server 119, a front end server 122, and a download server 124. The telephony server 116 relies on the database server 119 to determine the audio program and introductory message that corresponds to the dialed phone numbers of incoming calls. With the links provided by the database server 119, the telephony server 116 initiates streaming of the appropriate files from the download server 124. The front end server 122 provides a web site that serves as a phonecasting system interface for Internet users. Internet users typically will run web browser software on their computers 126. The web browser software displays a web page on their monitor 128, with one or more fields for the user to populate via an input device 132.

Among other things, Internet users will be able to enter Internet feed identifiers for, e.g., RSS (really simple syndication) feeds 134, 136. The front end server 122 accesses the database server 119 to determine whether phone numbers have previously been assigned, and if not, the front end server retrieves an available phone number from the database and assigns it to the feed. If the phone number is newly assigned, the front end server 122 also notifies the download server 124 to initiate retrieval and translation of the feed. Once a phone number has been assigned, the front end server 122 generates a web page for display on the user's computer monitor 128, showing the assigned phone number.

Though the illustrative system is shown as including four servers having separate functions, these functions can be consolidated and/or distributed as needed to provide the appropriate server capacity. FIG. 2 is a diagram of one embodiment of a network server 200, where the network server 200 may be, for example, the telephony server 116, the database server 119, the front end server 122, and/or the download server 124 of the phonecasting system of FIG. 1. The server 200 includes a memory 202, one or more processors 204, and a high-speed bridge that connects the processor(s) 204 with the memory 202 and the expansion bus 208. The expansion bus 208 supports communication with a peripheral interface 210, information storage device 212, network interface card 214, and an optional phone circuit interface card 216.

Peripheral interface 210 provides ports for communicating with external devices such as keyboard, mice, universal serial bus (USB) devices, printers, cameras, speakers, etc. On many servers, these ports may be left largely unused, but they are available for configuration, diagnostic, performance monitoring purposes. Information storage device 212 is typically a nonvolatile memory for firmware and/or a hard drive for extended storage of software and data. On distributed systems with high data availability requirements, the information storage device 212 is replaced or supplemented with a storage area network (SAN) card that enables shared access to a large disk array. A network interface card 214 provides access to other network servers and usually to the Internet as a whole. Finally, in the telephony server, an interface card for the telephone circuits is optionally included. In some alternative embodiments, the connection to the PSTN is accomplished indirectly via Voice over Internet Protocol (VoIP) techniques, eliminating the need for dedicated telephone circuit interface hardware.

Before the illustrative server 200 boots, the relevant phonecasting software components are stored on the local hard drive 212, or sometimes on a network disk accessible via the network interface card. After the initial boot-up diagnostics are completed, the processor(s) loads the phonecasting software components into memory, either all at once or on an “as needed” basis (e.g., by paging the needed instructions into memory). As the processor(s) execute the software instructions, the software configures the operation of the illustrative server(s) in accordance with the methods and principles set forth herein.

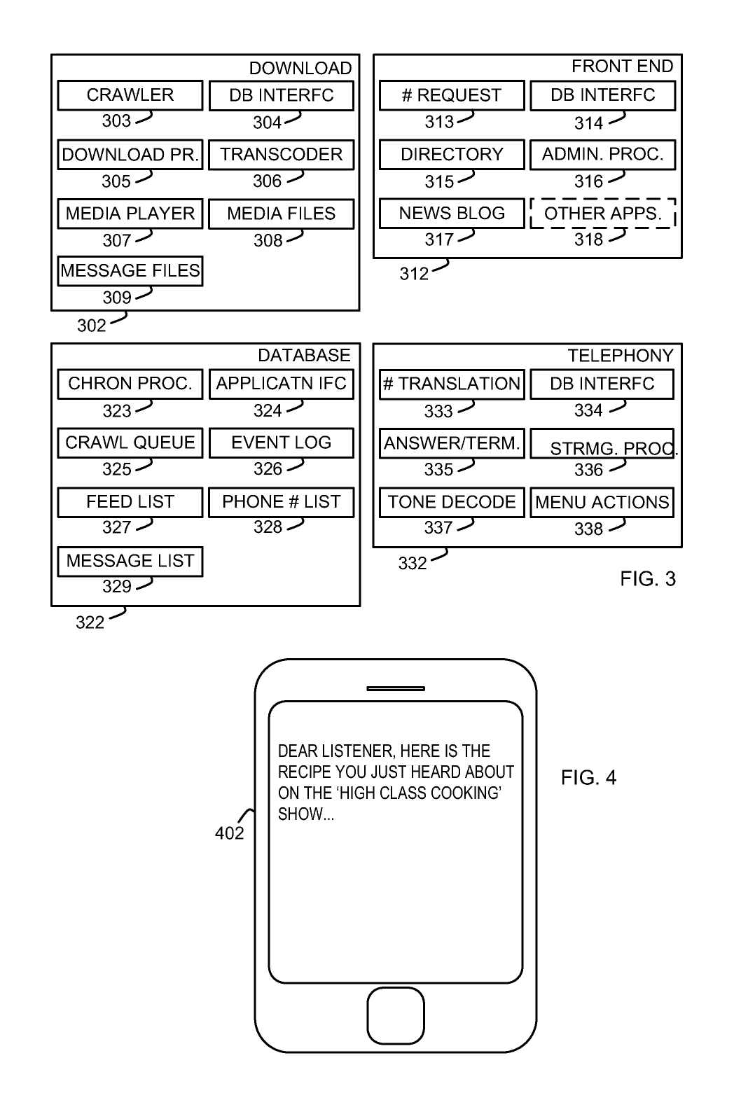

FIG. 3 is a function diagram of illustrative phonecasting system software. Though numerous independently executing processes exist, they can be grouped into four functional groups that correspond with the four servers of the illustrative phonecasting system: the telephony server, the database server, the front end server, and the download server. These will be addressed in reverse order, and initially at a high level. Thereafter, a more detailed discussion will be provided regarding a number of the more pertinent methods carried out by the phonecasting system.

The illustrative download software 302 performs an automated downloading and translation function to make Internet multimedia files locally available, and it optionally streams the multimedia files on demand. The illustrative download software 302 includes a crawler 303, a database interface 304, a download process 305, a translation process 306, a streaming media player 307, media file storage hierarchy 308, and message file storage hierarchy 309. The database interface process 304 establishes a connection to the database software 322 to assure coherent and reliable database access for the other download processes. Via the interface 304, the crawler 303 periodically retrieves a list of feeds that need to be checked for updates. The list includes information regarding the last download of the feeds, such as episode number, title, file size, and publication date. The crawler then checks the feeds on the Internet for updates or changes relative to the last download. If an update or other change is detected, the crawler 303 notifies the download process 305 to retrieve the latest version of the relevant audio or multimedia file. The illustrative download process 305 is designed to conduct multiple downloads with redundancy and tolerance for errors or temporary outages.

As the download process 305 completes the retrieval of each multimedia or sound file, the illustrative translation process 306 converts the audio component of the file into a format suitable for playback over a telephone connection. For example, MP3 files may be converted to uncompressed audio, re-sampled to 8 kHz monaural, and companded using a μ-law companding algorithm. In this format, the media player 307 can (upon demand) stream the file to a telephone connection with minimal processing. As the translation process 306 completes, the files are stored in the media file storage hierarchy 308 with any given standard naming convention, and the translation process 306 notifies the database process 305 of a successful download.

Audio or multimedia files may have corresponding textual and/or image files, referred to herein as “message files.” When downloading audio or multimedia files, crawler 303 may also download any corresponding message files, and store the message files in the message file storage hierarchy 309.

The illustrative front end software 312 provides a web interface to the phonecasting system. It includes a request component 313, a database interface process 314, a directory component 315, an administrative component 316, a news blog 317, and other optional applications 318. As before, the database interface process 314 establishes a connection to the database software 322 to assure coherent and reliable database access for the other front end processes. The request component 313, the directory component 315, the administrative component 316, and the news blog 317 may each take the form of web pages having fields for receiving user input and software modules for appropriately processing the user input. The illustrative request component 313, for example, includes a field for specifying a feed identifier, which if filled, causes the request component to obtain and display a phone number for that feed. The illustrative request component 313 first accesses the database to determine if a phone number has been previously assigned, and if not, the request component 313 requests that an available phone number from the database be assigned to the feed.

The illustrative directory component 315 enables keyword searching of the titles and identifiers for feeds having assigned phone numbers. The illustrative administrative component 316 enables an administrator to log in and monitor system operations. The administrator can further adjust usage thresholds for recycling relatively unused numbers (e.g., 60 days without a call), may add new blocks of phone numbers to the system, remove redundant numbers to a given feed, add additional numbers (or area codes) to heavily used feeds, and perform system backups. The news blog component 317 allows an administrator to publish the latest news and events for user convenience. Finally, the illustrative front end 312 includes other applications such as feed publishing utilities, podcast hosting services, and advertiser bidding utilities.

The illustrative database software 322 includes a chronology process 323, an application interface process 324, a crawl queue 325, an event log 326, a feed list 327, a phone number list 328, and a message list 329. The chronology process 323 periodically reviews the database tables for certain occurrences, such as the elapsing of a specified interval since the last time a feed was checked for an update, or the number of available numbers falling below a threshold. When such occurrences are detected, the chronology process 323 performs a specified action. In the case of a feed not being recently checked for an update, the chronology process 323 places the feed identifier in the crawl queue, where it will be seen the next time the crawl process 303 checks. In the case of too few available phone numbers, the chronology process 323 may send a message to a designated email address and/or initiate the execution of a phone number recycling process.

The application interface process 324 cooperates with the database interface processes 304, 314, and 334 to establish database connections with the other server software. Crawl queue 325 is a database table containing a list of feed identifiers that need to be checked for updates. Event log 326 is a table for tracking database transactions. Feed list 327 is a table containing a list of all the feeds with their assigned phone numbers. Phone number list 328 is a table containing a list of all the available (unassigned) phone numbers.

A feed may have one or more corresponding textual and/or image files, referred to herein as “message files” which are to be sent to the feed's listeners. Message list 329 is a table containing a list of all the feeds with their corresponding message files.

The illustrative telephony software 332 performs automated call completion, connecting telephone channels to the Internet feed associated with the dialed number. Illustrative software 332 includes a number translation module 333, a database interface process 334, a call answer/termination module 335, a streaming module 336, a tone decoding module 337, and a menu module 338. The number translation module 333 accesses the database to determine the feed or sound file and introductory message currently associated with the dialed phone number, and having determined them, passes the information to the call answer/termination module 335. Module 335 answers the call and monitors the connection while streaming module 336 coordinates with media player 307 to initiate playback of the introductory message and the sound file. If module 335 detects tone activity (e.g., from a caller pressing buttons on the keypad), the tone decode process 337 is invoked to determine which keys have been pressed. With the key presses determined module 335 can invoke the appropriate menu module 338. The menu module 338 generates the appropriate action, e.g., pausing, skipping forward or backward in the playback, switching to a previous/subsequent episode, playing a menu of other options, subscribing a user for future notifications, sending a text message, initiating a purchase of an advertised item, and so on.

FIG. 4 shows a mobile phone 402 displaying a portion of a received text message on a display screen. The displayed portion of the text message reads, “Dear Listener, Here is the recipe you just heard about on the ‘High Class Cooking’ show . . . ” A user of the mobile phone 402 (i.e., a caller) has used the mobile phone 402 to call a telephone number associated with a feed called the ‘High Class Cooking’ show, thereby establishing a telecommunications link with the phonecasting system of FIG. 1. In response, the phonecasting system of FIG. 1 plays an audio file corresponding to the feed, and provides a resulting audio signal to the caller via the telecommunications link. The audio content of the feed, contained in the audio file, gives a verbal description of the recipe. The audio file has a corresponding message file containing the text message. While playing the audio file, the phonecasting system of FIG. 1 sends the text message to the caller, where the text message includes the recipe. In some embodiments, the corresponding message file may contain one or more images.

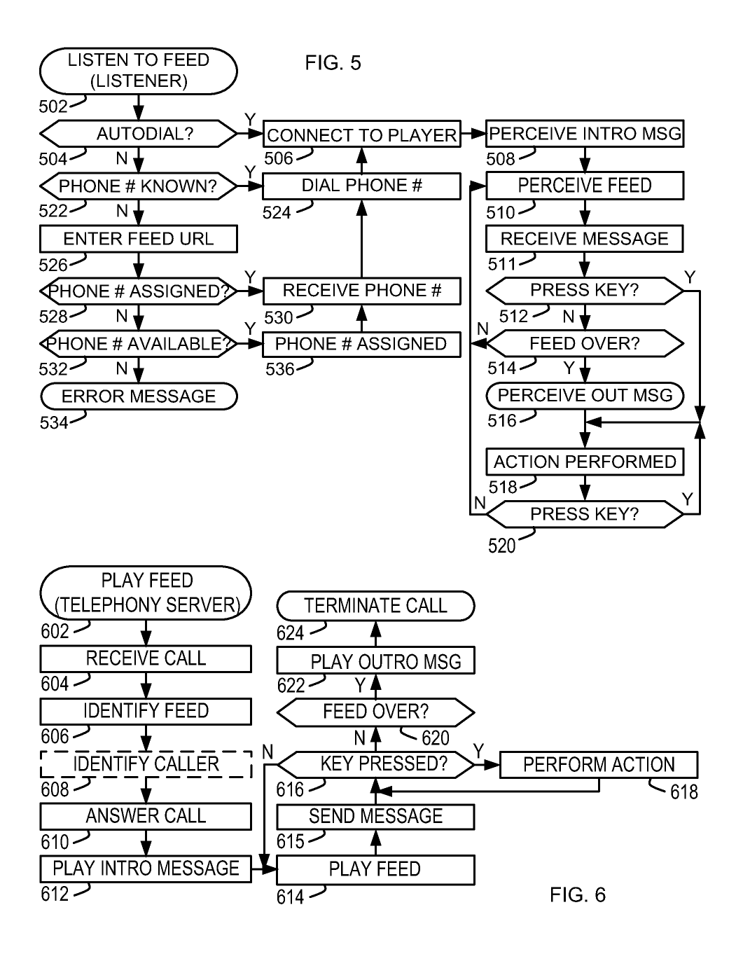

FIG. 5 is a flowchart of an illustrative phonecast listening method 502. Beginning in block 504, a user chooses whether or not to autodial a phonecast number. The autodial feature can be made available in a number of ways. One autodial method involves programming a speed dial or voice-recognition system to dial the phonecast number on demand. Another autodial method involves scanning a barcode or RFID (radio frequency identification) tag that provides (directly or indirectly) a phone number to a mobile phone. Yet another autodial method involves a “click to call” link embedded in a webpage, email, or SMS (short message service) message that invokes the computer or phone's autodialing function. These and other autodial methods enable a user to easily command a phone to call a phonecast number, so that the phone connects to a phonecast player in block 506.

In block 508, the listener hears (audio) or sees (video) an introductory message. The introductory message may be a simple welcoming message, a general advertisement, or a targeted advertisement selected on the basis of the caller ID information and/or the content of the feed. Though the introductory message can be limited to 10 or 15 seconds, other introductory message lengths are possible and may be desirable. In some system embodiments, the listener is unable to use pause or skip functionality during the introductory message.

Once the introductory message terminates, the listener hears (audio) or views (video) the feed in block 510. In block 511, the listener receives a message corresponding to what he or she is hearing (audio) or seeing (video). In block 512 the listener can provide user input, e.g., in the form of a key press or voice command, until the feed terminates in block 514. (Once the feed ends, the listener hears or sees an “outro” or closing message as the call terminates in block 516.) If the user provides user input in block 512, the system optionally pauses the feed to perform the action that is triggered by the user input in block 518. Absent further user input in block 520, the phonecast resumes in block 510.

In block 511, the listener receives a text or email message corresponding to a feed. The feed may be provided by a phonecasting system. During, or shortly after, the providing of the feed, the phonecasting system may send a text or email message to the listener to provide additional information. The text or email message may be sent automatically or in response to the listener's request, and may include supplementary information such as recipes, coupons, specifications, retail locations, or other details deemed beneficial to the listener.

A number of actions may be made available to the user in blocks 512, 518, and 520. Such actions include pausing the feed, skipping ahead, and skipping backward. Another possible action may be subscribing for instant notification of future updates to the material, in which case the system may capture caller identification (CID) or automatic number identification (ANI) information to enable voice mail or SMS message notifications to be sent. Another possible action may be initiating a purchase of some product or service discussed in the feed. Again, the system would capture the CID or ANI information and arrange to have the user's phone service provider provide delivery information and send a bill for the product or service.

Returning to block 504, if the autodialing option is not available, the user determines if he knows the phonecast phone number in block 522. The number may be known if the user has previously stored or memorized the number, or if it if being provided by an advertisement or by a friend. If the number is known, the user can dial the number in block 524 and the method proceeds as before.

If the number is not known in block 522, the user accesses the front end software in block 526 and enters a feed identifier into a phone number request field. In block 528, the system determines if a phone number has been previously assigned, and if so, the user receives the phone number in block 530. If no number is currently assigned, the system determines in block 532 whether any unassigned phone numbers are available, and if so, the system assigns a phone number in block 536. Otherwise, an error message is presented in block 534, and a notification is sent to the administrator so that the situation can be rectified.

FIG. 6 is a flowchart of an illustrative phonecast playback method 602. Beginning in block 604, the telephony server receives a call to a dialed number. In block 606, the telephony server accesses the database to determine which feed or multimedia file is currently associated with that dialed number. In optional block 608, the telephony server collects the CID or ANI information. If collected, this information may be used for statistics generation, targeted advertising, subscription services, notification services, and purchasing services. In block 610, the telephony server answers the call, and in block 612, the telephony server initiates playback of an introductory message 612. In at least some method embodiments, playback pause and skip-forward functionality is suspended during the introductory message. After the introductory message finishes, the telephony server initiates playback of the feed corresponding to the dialed number in block 614. In block 615, the telephony server initiates the sending of a message corresponding to the feed. In blocks 616 and 618, the telephony server detects user input and performs the corresponding actions. Such user interaction may be allowed to continue until the system determines that the feed is complete (or that the user terminated the connection) in block 620. Once the feed is complete, the telephony server optionally plays a closing message in block 622 and terminates the call in block 624.

Referring back to FIG. 1, the phonecasting system of FIG. 1 may implement the phonecast playback method 602 of FIG. 6. In one embodiment, the phonecasting system of FIG. 1 receives a telephone call from a caller via a telephone number, and plays an audio file including audio content corresponding to the telephone number in response, thereby producing an audio signal. The phonecasting system provides the audio signal to the caller, and selectively sends a message to the caller while providing the audio signal to the caller.

The audio file may include, for example, a podcast publicly available via the Internet. The audio file may also include an audio advertisement or public service message. The message corresponds to the audio file, and may be, for example, a text message or an electronic mail (email) message. Alternatively, or in addition, the message may be or include one or more images (e.g., pictures, drawings, diagrams, and the like).

The telephony server 116 may be configured to provide the audio signal to the caller. The telephony server 116 may also be configured to send the message corresponding to audio file to the caller while providing the audio signal to the caller. As described above, the media player 307 of the database server 119 may be configured to play the audio file.

The playing of the audio file may begin at a start time and end at an end time. The message may be sent to the caller at the start time. Alternatively, the message may be sent to the caller after a programmable delay time elapses following the start time. Further, the message may be sent to the caller at the end time.

As described above, the phonecasting system of FIG. 1 includes several servers. Each server may include a memory that stores software, and processor(s) coupled to the memory to execute the software. In one embodiment, software stored in the memory of one or more of the servers configures the processor(s) to: receive a telephone call from a caller via a telephone number, thereby establishing a telecommunications link; play an audio file including audio content corresponding to the telephone number, thereby producing an audio signal; provide the audio signal to the caller via the telecommunications link; and send a message including visual content corresponding to the audio content to the caller.

The audio content may be, for example, a text-to-voice rendering of a document available on the World Wide Web (i.e., a Web page), a podcast, a song, or an audio feed from the Internet. The message may be, for example, a text message sent using the short message service (SMS) protocol. As described above, the playing of the audio file may begin at a start time. The message may be sent to the caller if the telecommunications link has not been terminated before a programmable delay time elapses following the start time. The visual content may include, for example, textual information. Alternatively, or in addition, the visual content may include one or more images (e.g., pictures, drawings, diagrams, and the like).

In some embodiments, the message is a text message. The software may configure the processor(s) to determine if a telephone used by the caller is capable of receiving text messages, and the text message may be sent to the caller only if the telephone used by the caller is capable of receiving text messages. For example, the phonecasting system of FIG. 1 may include a database including a list of users (i.e., callers) and information as to whether each caller can receive text messages. The software may configure the processor(s) to access the database to determine if a telephone used by a particular caller is capable of receiving text messages.

In some embodiments, the software may configure the processor(s) to receive caller input indicative of whether the caller wishes to receive a text message. In such embodiments, the text message may be sent to the caller only if the caller input indicates the caller wishes to receive the text message. For example, the software may configure the processor(s) to transmit a voice prompt to the caller saying something like, “Would you like to receive a text message including a copy of the recipe from today's show? If so, press ‘1’ now.” The text message including a copy of the recipe would only be sent to the caller if he or she presses the number ‘1’ on a keypad of his her phone within a predetermined period of time.

In one embodiment of a method for conveying audio content and corresponding visual content, a telephone call is received from a caller via a telephone number, thereby establishing a telecommunications link. In response, a phonecast is played, thereby producing an audio signal. The audio signal is provided to the caller via the telecommunications link, and a text message is automatically sent to that caller, where the text message include visual content. As described above, the visual content may include, for example, textual information. Alternatively, or in addition, the visual content may include one or more images (e.g., pictures, drawings, diagrams, and the like).

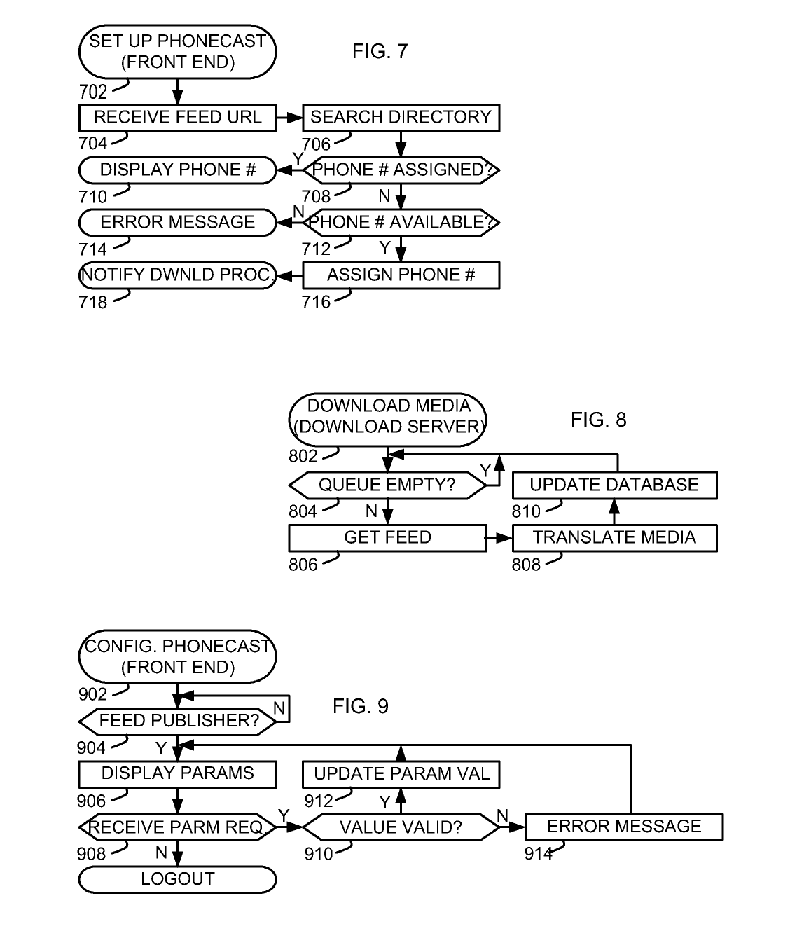

FIG. 7 is a flowchart of an illustrative Internet-based phonecast setup method 702. Beginning in block 704, the front end server receives a feed identifier such as a URL for a podcast. In block 706, the front end server searches a database or other form of directory to determine if the feed identifier already has a phone number assigned. In block 708, the front end server checks to determine if the search was successful, and if so, the front end provides the phone number for display to the source of feed identifier. If the search was unsuccessful, the front end server determines in block 712 whether any phone numbers are available for it to assign to the feed, and if not, the front end sends an error message in block 714. If a number is available, the front end server assigns the phone number to the feed in block 716 (by updating the database or directory) and notifies the download software that new content needs to be retrieved and prepared for phonecasting.

Note that the method described in FIG. 7 is not limited to web page-based data entry and response. The publicly-accessible front end server may be configured to receive and respond to phone number requests with feed identifiers in a variety of formats, including email, SMS messages, XML files, and other communication methods.

FIG. 8 is a flowchart of an illustrative automated download method 802 that may be implemented by the download server. Beginning in block 804, the download software determines whether the download queue is empty. The download queue lists files for retrieval by the download software, along with desired destination and a subroutine call to specify success or failure of the retrieval attempt. The download queue may be populated with new feeds by the front end server, and with updated feeds by a crawler component of the download software. In each case, the new or updated content will be associated with a corresponding phone number once the download is complete.

If the download queue is not empty, then in block 806, the download software retrieves the feed and any associated message files. (Although the download software makes provisions for temporary outages and failures, that level of detail is not of crucial importance to this disclosure.) In block 808, the download software translates the feed from its original format to a phonecasting format as described previously. In block 810, the download software notifies the database that the feed is ready for phonecasting.

FIG. 9 is a flowchart of an illustrative phonecast parameter configuration method 902. Beginning in block 904, the front end determines whether or not it is the feed publisher that is attempting to configure the phonecast. This determination can be performed by having the phonecast publisher log in to an account, or otherwise provide verification that the publisher is who they claim to be. In some cases the publisher may be asked to include a verification code in their syndication file to establish their identity.

In block 906, the front end software displays the current phonecast parameters. In block 908, the front end determines whether the publisher wishes to modify any parameters, and if not, the process terminates. Otherwise, in block 910, the front end determines whether the new parameter value is valid or not. If so, the front end updates the parameter value in block 912. If not, an error message is published in block 914, and the updated parameter values are redisplayed in block 906. Examples of the various parameter values that can be set are provided in the following figure.

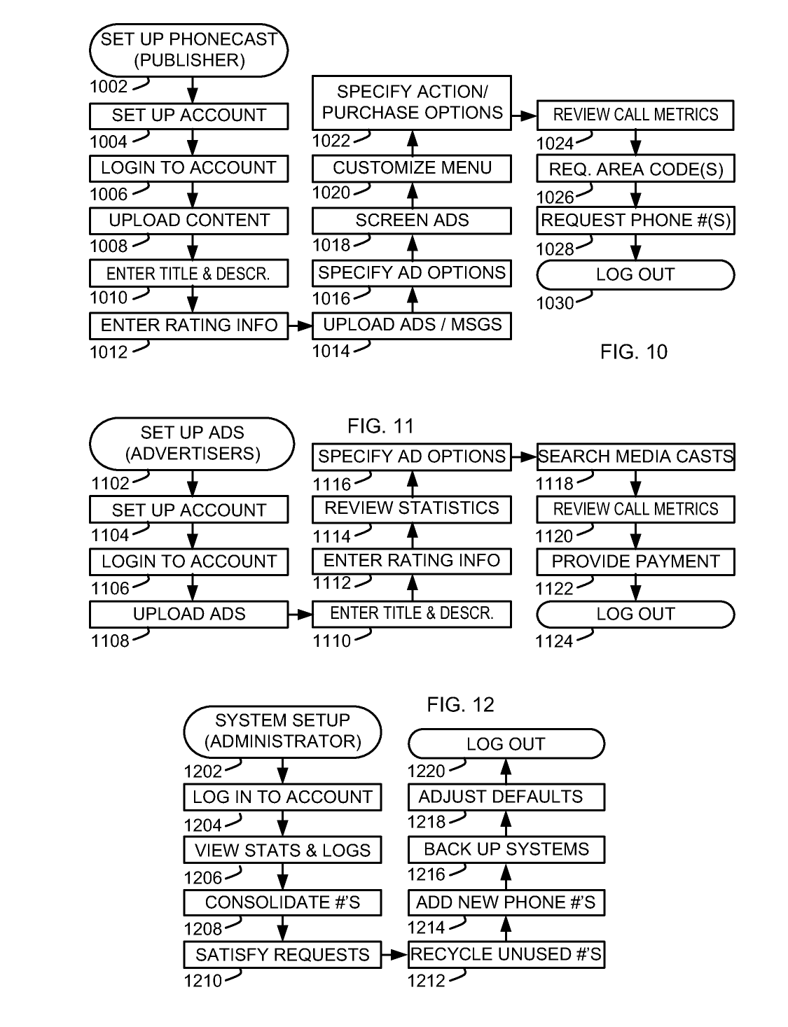

FIG. 10 is a flowchart of an illustrative phonecast setup method for publishers 1002. Beginning in block 1004, the publisher sets up an account in the podcasting system. The account setup process provides some mechanism for assuring that the person setting up the account is indeed the publisher or somebody operating on the publisher's behalf In block 1006, the publisher logs into his account. In block 1008, the publisher uploads a feed to the podcasting system. This action is optional and may be unnecessary unless the publisher is using the podcasting system as his hosting system. In block 1010, the publisher enters a title and description for the feed, and in block 1012, the publisher enters rating information. Again, these actions are optional and may be unnecessary if the feed is syndicated on the Internet, in which case the podcasting system can retrieve this information automatically.

In block 1014, the publisher has the option to upload introductory advertisements and/or text messages for use with his podcast. In some method embodiments, the publisher may be expected to pay for this option. In block 1016, the publisher can specify options for the messages or advertisements, including desired budget, desired presentation frequency, desired targeting parameters (e.g. ANI/CID area codes), calendar schedules for different ads, limitations on third party advertisements (e.g., no automotive ads, or no competitor ads), and so on. In block 1018, the publisher may be presented with the ads he has uploaded and any third party ads that qualify under the options he has set, as part of a screening process. The publisher may be permitted to reject ads or affirmatively select or express preferences regarding the screened ads.

In block 1020, the publisher may customize menu options for the podcast listener, including custom voice menus for listeners that provide user inputs requesting standard actions (pause, skip, notification subscription, listen to previous episode, receive text message, etc). In block 1022, the publisher can specify unique actions or purchase options that are triggered by the appropriate user inputs. For example, certain keys might be designated as voting keys for users to participate in surveys, or a key may be provided to request more information about the current topic, etc. Publishers may be given access to a set of customizable action modules that will be triggered by the appropriate key press or voice input.

Continuing with the present setup example, in block 1024, the publisher may review call metrics, i.e., statistics about the numbers, frequencies, distributions, and lengths of calls to the podcast. Based in part on such statistics, the publisher may request numbers in specific area codes in block 1026, or even request a specific vanity number in block 1028. It should be noted that the sequence of actions described here is illustrative and can be readily re-arranged with certain actions added or omitted per the immediate needs of the publisher. Once finished with the setup process, the publisher logs out in block 1030.

FIG. 11 is a flowchart of an illustrative ad setup method 1102 for advertisers. Beginning in block 1104, the advertiser sets up an account. This action only needs to be performed once per advertiser. In block 1106, the advertiser logs in to his account and uploads advertisements in block 1108. In block 1110, the advertiser enters titles and short descriptions of the advertisements, and further provides rating information in block 1112. In block 1114, the advertisers can review the statistics for their advertisements, such as number of times presented, frequency on each podcast, average frequency to each CID, advertising costs, and so on. In block 1116, the advertisers can specify their advertising options including calendar limitations, podcast rating limitations, maximum number of ad showings, and so on. In block 1118, the advertisers may search or screen a list of podcasts to specify preferences or prohibitions for advertising on certain podcasts. In block 1120, the advertisers may also review the call statistics for selected podcasts to verify that the have sufficient call volume and coverage of the desired markets (e.g., area codes or other CID/ANI data that may be indicative of geographic or demographic markets). In block 1122, the advertisers can provide payment information and/or bids for their desired advertising parameters. As before, the sequence of actions described here is illustrative and can be readily re-arranged with certain actions added or omitted per the immediate needs of the advertiser. Once finished with the setup process, the advertiser logs out in block 1124.

FIG. 12 is a flowchart of an illustrative phonecast system setup method for administrators 1202. Beginning with block 1204, the administrator logs into his account. In block 1206, the administrator reviews the logs and performance statistics of the phonecasting system for any sign of problems, such as available capacity, congestion, adequate resources (including unassigned phone numbers). In block 1208, the administrator reviews feed identifiers identified by a consolidation process as being suspiciously similar or redundant. If the administrator identifies the feeds as being the same, the administrator consolidates them, so that all the associated phone numbers will refer to the same feed. If the resulting group of phone numbers is excessive, the lesser-used phone numbers may be designated for a “phase out”, i.e., a message referring callers to one of the remaining phone numbers for that feed.

In block 1210, the administrator reviews manual configuration requests. Primarily, these requests are expected to be multiple phone numbers for a given feed (e.g., one phone number in each area code for a national or regional program), and requests for a specific “vanity” number for a given feed. To the extent that the software doesn't handle such requests automatically, the administrator may manually make the necessary changes to the database to satisfy those requests that can be feasibly satisfied.

In block 1212, the administrator recycles phone numbers that have been assigned to feeds but are relatively unused (e.g., no calls in the last 60 days). This action may be unnecessary so long as an adequate pool of numbers remains available. Conversely, if this action is insufficient, the administrator may add a new block of phone numbers to the pool in block 1214. In block 1216, the administrator initiates a backup of the and database and current configurations of the software. In block 1218, the administrator adjusts the defaults if needed. Such defaults may include thresholds for number recycling, crawling frequencies to check for updates, archived episode age limits, and so on. The sequence of actions described here is illustrative and can be readily re-arranged with certain actions added or omitted per the immediate needs of the administrator. Once finished, the advertiser logs out in block 1220.

In summary, a number of novel phonecasting system and method embodiments have been disclosed. Numerous variations and modifications will become apparent to those skilled in the art once the above disclosure is fully appreciated. It is intended that the following claims be interpreted to embrace all such variations and modifications.

As one example, the illustrative methods shown in the figures present actions in a sequential series. Those skilled in the programming arts are aware of various parallel and distributed programming methods that can achieve similar results while permitting similar actions to be taken out of sequence, concurrently, or simply as needed. Moreover, the sequences shows are given for illustrative purposes, and in practice many of the actions would be re-ordered, omitted, inserted, or repeated as desired.

As another example, the telephony software can be readily extended to buffer, translate, and play live audio streams publicly available on the Internet. For such feeds, some or all of the download server operations may be omitted.

In some system embodiments, the phonecasting system includes a “resume” feature. When the telephony server in such a system detects that the call has been terminated by the caller before the end of the phonecast, the telephony server records the termination time (i.e., the position within the audio program at which the call was terminated) and stores it in the database in a record associated with caller identification (Caller ID) information. When the system receives a subsequent call from that caller, the telephony server checks the database to determine if the caller has heard any portion of the audio feed associated with the called number. If so, the system (potentially after re-playing the introductory message) initiates playback of the audio feed near the position at which the call was terminated. This feature enables a listener to receive a phonecast in short segments over many different phone calls. In some implementations, the position information is reset each time the phonecast content is updated. In other implementations, the position information is tracked for each episode of the phonecast, so that a listener accessing a previous episode (e.g., through a menu) can pick up where they left off.

When caller ID information is employed in this manner, it becomes possible to provide other customizable features to each caller. For example, the operation of the resume feature may be programmable by the caller to enable the caller to choose whether the playback automatically begins with the newest episode when they call, or whether the default is to continue listening where they left off even if a newer episode has become available.

A number of applications of the disclosed systems and methods should be readily apparent. Phonecasts can be used as a type of audible directory, with service providers providing descriptions of their services or goods and inviting the listener to press a key to initiate a purchase, to connect to a live consultant, or to receive a text message having further information such as product specifications, configurations, pricing, promotions, coupon codes, store hours and locations. Products ranging from real estate to books can include phone numbers that connect a caller to a current, audible program, supplemented with text messages having current details about property pricing, product options, or author biographies, thereby highlighting the relevance of established products to current consumer interests even long after the original introduction of the product to the market. Artists can have phone numbers assigned to their latest longs or albums so that the public can sample their work and “press 5 to have this music delivered digitally to your phone.” Callers may receive text messages with song lyrics or artist biographies to pique their interest in other songs from the artist. Phonecast cooking shows can be sponsored by supermarkets or product manufactures that send shopping lists, coupons, and/or recipes to listeners to encourage product sales. These are just some of the many illustrative applications that are enabled by the foregoing disclosure.

What is claimed is:

1. A phonecasting system, comprising:
means for receiving a telephone call from a caller via a telephone number and providing an audio signal in response;
means for playing an audio file comprising audio content corresponding to the telephone number, thereby producing said audio signal; and
means for sending a text message to the caller while providing the audio signal to the caller.

2. The phonecasting system as recited in claim 1, wherein the means for receiving the telephone call comprises a telephony server configured to provide the audio signal to the caller.

3. The phonecasting system as recited in claim 2, wherein the telephony server is configured to send the text message to the caller while providing the audio signal to the caller.

4. The phonecasting system as recited in claim 1, wherein the means for playing the audio file comprises a media player.

5. The phonecasting system as recited in claim 1, wherein the audio file comprises a podcast publicly available via the Internet.

6. The phonecasting system as recited in claim 1, wherein the audio file comprises an audio advertisement or public service message.

7. The phonecasting system as recited in claim 1, wherein the playing of the audio file begins at a start time, and the text message is sent to the caller at the start time.

8. The phonecasting system as recited in claim 1, wherein the playing of the audio file begins at a start time, and the text message is sent to the caller after a programmable delay time elapses following the start time.

9. The phonecasting system as recited in claim 1, wherein the playing of the audio file ends at an end time, and the text message is sent to the caller at the end time.

10. A phonecasting system, comprising:
a memory that stores software;
at least one processor coupled to the memory to execute the software, wherein the software configures the at least one processor to:
receive a telephone call from a caller via a telephone number, thereby establishing a telecommunications link;
play an audio file comprising audio content corresponding to the telephone number, thereby producing an audio signal;
provide the audio signal to the caller via the telecommunications link; and
send a message comprising visual content corresponding to the audio content to the caller.

11. The phonecasting system as recited in claim 10, wherein the message is an electronic mail (email) message.

12. The phonecasting system as recited in claim 10, wherein the message is a text message.

13. The phonecasting system as recited in claim 12, wherein the software further configures the at least one processor to determine if a telephone used by the caller is capable of receiving text messages, and wherein the text message is sent to the caller only if the telephone used by the caller is capable of receiving text messages.

14. The phonecasting system as recited in claim 13, wherein a database is accessed to determine if the telephone used by the caller is capable of receiving text messages.

15. The phonecasting system as recited in claim 10, wherein the audio file comprises a podcast publicly available via the Internet.

16. The phonecasting system as recited in claim 10, wherein the audio file comprises an audio advertisement or public service message.

17. The phonecasting system as recited in claim 10, wherein the playing of the audio file begins at a start time, and the message is sent to the caller at the start time.

18. The phonecasting system as recited in claim 10, wherein the playing of the audio file begins at a start time, and the message is sent to the caller if the telecommunications link has not been terminated before a programmable delay time elapses following the start time.

19. The phonecasting system as recited in claim 10, wherein the playing of the audio file ends at an end time, and the message is sent to the caller at the end time.

20. The phonecasting system as recited in claim 10, wherein the visual content comprises textual information.

21. The phonecasting system as recited in claim 10, wherein the visual content comprises at least one image.

22. The phonecasting system as recited in claim 10, wherein the software further configures the at least one processor to receive caller input indicative of whether the caller wishes to receive a text message, and wherein the text message is sent to the caller only if the caller input indicates the caller wishes to receive the text message.

23. The phonecasting system as recited in claim 10, wherein the audio content is a text-to-voice rendering of a document available on the World Wide Web.

24. A method for conveying audio content and corresponding visual content, comprising:
receiving a telephone call from a caller via a telephone number, thereby establishing a telecommunications link;
playing a phonecast, thereby producing an audio signal;
providing the audio signal to the caller via the telecommunications link; and
sending a text message comprising visual content to the caller.

25. The method as recited in claim 24, wherein the audio file comprises a podcast publicly available via the Internet.

26. The method as recited in claim 24, wherein the audio file comprises an audio advertisement or public service message.

27. The method as recited in claim 24, wherein the playing of the audio file begins at a start time, and the text message is sent to the caller at the start time.

28. The method as recited in claim 24, wherein the playing of the audio file begins at a start time, and the text message is sent to the caller after a programmable delay time elapses following the start time.

29. The method as recited in claim 24, wherein the playing of the audio file ends at an end time, and the text message is sent to the caller at the end time.

30. The method as recited in claim 24, wherein the visual content comprises textual information.

31. The method as recited in claim 24, wherein the visual content comprises at least one image.

32. The method as recited in claim 24, further comprising:
determining if a telephone used by the caller is capable of receiving text messages;
wherein the sending of the text message is carried out only if the telephone used by the caller is capable of receiving text messages.

33. The method as recited in claim 24, further comprising:
receiving caller input indicative of whether the caller wishes to receive a text message;
wherein the sending of the text message is carried out only if the caller input indicates the caller wishes to receive the text message.
